(19) United States
(12) Patent Application Publication
(10) Pub. No.: US 2004/0073903 A1
(43) Pub. Date: Apr. 15, 2004

(54) Providing access to software over a network via keys

(75) Inventors: Daniel Joseph Melchione, Beaverton, OR (US); Ricky Y. Huang, Portland, OR (US); Charles Leslie Vigue, LaPine, OR (US); Charles Corey Capel, Beaverton, OR (US)

Correspondence Address: KLARQUIST SPARKMAN, LLP, 121 SW SALMON STREET, SUITE 1600, PORTLAND, OR, 97204, US

(73) Assignee: Secure Resolutions,Inc.

(21) Appl. No.: 10/421,242

(22) Filed: Apr. 22, 2003

Related U.S. Application Data
(60) Provisional application No. 60/375,174, filed on Apr. 23, 2002.

(51) Int. Cl. G06F 9/44

(52) U.S. Cl. 717/172

(57) ABSTRACT

A method and system for providing access to software is described. A network reference (e.g., a URL) comprising a key is provided to a computer in an organization. The key can be used to download software. The key can be associated with data such as identifiers for the organization or groups within the organization. Additional network references comprising other keys also may be provided for other groups within the organization. The network reference can be generated via a request over a network in an application service provider scenario. When a request for software associated with the key is received, the key can be validated by comparing against a set of valid keys stored in a data center. Keys can be individually revoked within an organization. Downloading computers can access server computers via a web browser over an Internet connection. A node requesting software via a key can be placed into the group associated with the key. The key can be used to install agent software by which software administration in an application service provider scenario can be accomplished.

### PRIORITY CLAIM

This application claims the benefit of U.S. Provisional Patent Application No. 60/375,174, filed Apr. 23, 2002, which is hereby incorporated herein by reference.

### CROSS-REFERENCE TO OTHER APPLICATIONS

The U.S. provisional patent applications No. 60/375,215, Melchione et al., entitled, “Software Distribution via Stages”; Ser. No. 60/375,216, Huang et al., entitled, “Software Administration in an Application Service Provider Scenario via Configuration Directives”; Ser. No. 60/375,176, Vigue et al., entitled, “Fault-tolerant Distributed Computing Applications”; Ser. No. 60/375,154, Melchione et al., entitled, “Distributed Server Software Distribution,”; and Ser. No. 60/375,210, Melchione et al., entitled, “Executing Software In A Network Environment”; all filed Apr. 23, 2002, are hereby incorporated herein by reference.

### TECHNICAL FIELD

This invention relates to methods and systems for installing software on computers, and more particularly to providing access to software for installation in a network environment.

### COPYRIGHT AUTHORIZATION

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Organizations with large numbers of computer users face significant hurdles in keeping software on their computers up to date. Human resource costs of installing and updating software on hundreds or even thousands of computers within an organization can be immense. Efficiently updating, installing, and running new software is important in any computing environment, and particularly in organizations with large numbers of computer users.

If software is not efficiently distributed, installed, and updated, information technology personnel must perform individual software installations on each computer on the network. Given the amount of time that must be devoted to such a task, software that is frequently updated by the manufacturer (e.g., anti-virus software) may undergo several important updates during the time it takes for information technology personnel in an organization to perform just one update on each computer in the organization.

The traditional approach of purchasing shrink-wrapped software and performing installations manually on several individual computers within an organization has become outdated for several reasons. First, in terms of numbers of installations required in large organizations, the time and resources needed for performing the installations is prohibitive. Second, in recent years, many software manufacturers have begun releasing updates to their software more frequently in order to keep the software's functionality up-to-date and to quickly fix known bugs in the software. Third, the rapid development of Internet technology has created faster, more efficient methods of delivering new software and updating existing software via Internet connections.

### SUMMARY

Various techniques for providing access to software are described herein. For example, a network reference (e.g., a Uniform Resource Locator) can be provided to at least one computer associated with an organization. The network reference can comprise a key (e.g., a token) associated with the organization by which software can be downloaded from a server computer. More than one token can be associated with the organization, and tokens can be separately controlled (e.g., revoked or set to expire).

In some embodiments, a database associates the key with the organization and a group within the organization. Responsive to a computer acquiring and installing software via the key, the computer can be associated with the organization and group. Additional network references comprising additional keys for other groups in the organization also may be provided to other computers associated with the organization.

A token can be generated responsive to a request over a network by one of the plurality of computers associated with the organization (e.g., in an application service provider scenario). Such a request may comprise providing data (such as expiration date, a key name, or a group) to be associated with the key in a database.

The software to be downloaded can comprise anti-virus software. Or, the software can comprise agent software for implementing configuration directives from a data center via an application service provider. The downloaded software may be an update of existing software.

Validating a key provided by a downloading computer in a request to download software can comprise searching for a matching key in a set of valid keys stored in a data center. If a match is found, at least one download of the software may be downloaded. Valid keys may be associated with configuration data. Keys within an organization can be individually revoked or otherwise configured or controlled. A key may be valid for a finite number of uses.

In another embodiment, where downloading computers are of a plurality of computers associated with an organization, one or more downloading computers can access a server computer (e.g., via a web browser over an Internet connection). The accessing comprises processing a network reference (e.g., a Uniform Resource Locator) comprising a key associated with the organization. A downloading computer requests a download of software by providing the key as input to the server computer. The key may comprise a token identifier, and may be associated with a defined group of computers in the organization. The software may then be downloaded.

When a key is used for installation of software, the node on which the software is installed can be automatically placed within a group associated with the key. In this way, the key can be used to distribute software to a set of nodes and place them into a group, even if the nodes have not yet been registered in a database. Configuration directives can be applied to the group via an application service provider scenario. Subsequently, a node can be moved to a different group.

A system for downloading software over a network is also described. Such a system may comprise, for example, a data center operable to generate network references (e.g., Uniform Resource Locators) comprising a key, such as a token, for authorizing downloading of software, and a communication link to a network, where the communication link allows communication between the data center and a computer accessing the data center.

Any of the embodiments described herein may be practiced in an application service provider scenario. For example, a token can be provided via an application service provider scenario. If a token is used to install agent software, the agent can administer software via an application service provider scenario.

Additional features and advantages will be made apparent from the following detailed description of illustrated embodiments, which proceeds with reference to the accompanying drawings.

### BRIEF DESCRIPTION OF THE DRAWINGS

FIG. 1 is an illustration of an exemplary application service provider scenario.

FIG. 2 is an illustration of an exemplary arrangement by which software administration can be accomplished via an application service provider scenario.

FIG. 3 depicts an exemplary user interface by which software administration can be accomplished in an application service provider scenario.

FIG. 4 illustrates an exemplary business relationship accompanying an application service provider scenario, such as that shown in FIGS. 1 or 2.

FIG. 5 is an illustration of an exemplary arrangement by which software can be downloaded via a network to a computer.

FIG. 6 is a flow chart illustrating an exemplary method for generating a network reference.

FIG. 7 a flow chart illustrating an exemplary method for acquiring software via a network reference.

FIG. 8 is an illustration of a hierarchy of organization, token, group, and node identifiers.

FIG. 9 depicts an exemplary user interface by which tokens can be managed.

FIG. 10 depicts an exemplary user interface by which tokens can be created.

FIG. 11 depicts an exemplary user interface by which token information can be updated or edited.

FIG. 12 depicts an exemplary user interface by which token network reference information can be presented.

FIG. 13 shows an exemplary network reference comprising a token identifier.

FIG. 14 depicts an exemplary scenario in which a vendor hosts application services and provides tokens for more than one organization.

FIG. 15 shows an exemplary arrangement involving anti-virus software.

### DETAILED DESCRIPTION

### Application Service Provider Overview

The embodiments described herein can be implemented in an application service provider scenario. In particular embodiments, software administration can be accomplished via an application service provider scenario.

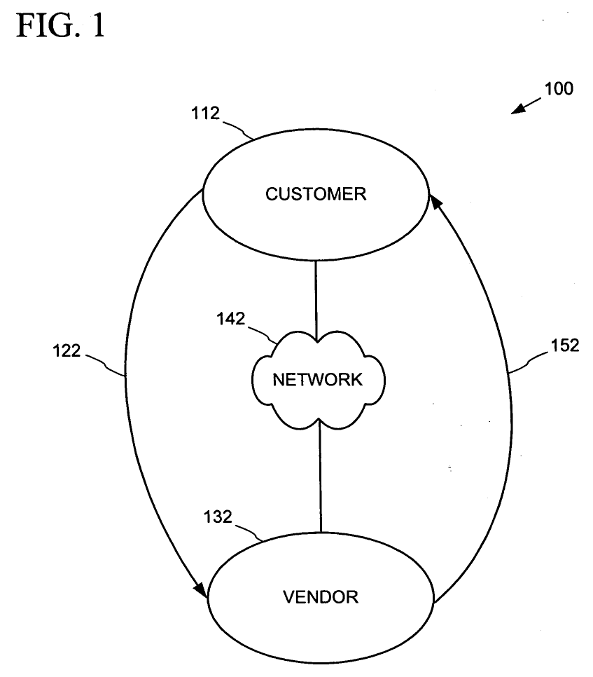

An exemplary application service provider scenario 100 is shown in FIG. 1. In the scenario 100, a customer 112 sends requests 122 for application services to an application service provider vendor 132 via a network 142. In response, the vendor 132 provides application services 152 via the network 142. The application services 152 can take many forms for accomplishing computing tasks related to a software application or other software.

To accomplish the arrangement shown, a variety of approaches can be implemented. For example, the application services can include delivery of graphical user interface elements (e.g., hyperlinks, graphical checkboxes, graphical pushbuttons, and graphical form fields) which can be manipulated by a pointing device such as a mouse. Other application services can take other forms, such as sending directives or other communications to devices of the vendor 132.

To accomplish delivery of the application services 152, a customer 112 can use client software such as a web browser to access a data center associated with the vendor 132 via a web protocol such as an HTTP-based protocol (e.g., HTTP or HTTPS). Requests for services can be accomplished by activating user interface elements (e.g., those acquired by an application service or otherwise) or automatically (e.g., periodically or as otherwise scheduled) by software. In such an arrangement, a variety of networks (e.g., the Internet) can be used to deliver the application services (e.g., web pages conforming to HTML or some extension thereof) 152 in response to the requests. One or more clients can be executed on one or more devices having access to the network 142. In some cases, the requests 122 and services 152 can take different forms, including communication to software other than a web browser.

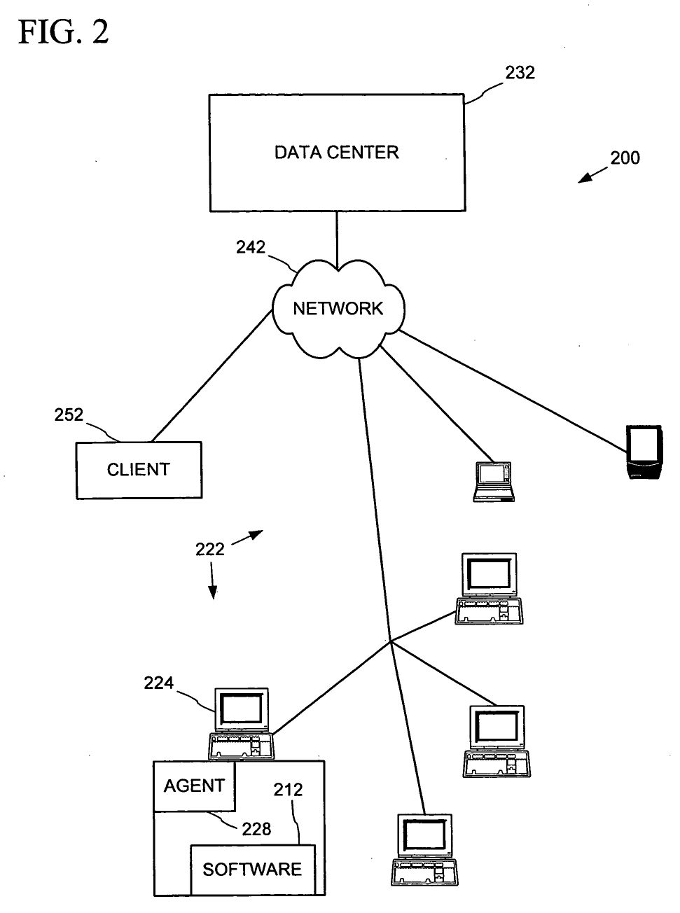

The technologies described herein can be used to administer software (e.g., one or more applications) across a set of administered devices via an application service provider scenario. Administration of software can include software installation, software configuration, software management, or some combination thereof. FIG. 2 shows an exemplary arrangement 200 whereby an application service provider provides services for administering software (e.g., administered software 212) across a set of administered devices 222. The administered devices 222 are sometimes called “nodes.”

In the arrangement 200, the application service provider provides services for administrating instances of the software 212 via a data center 232. The data center 232 can be an array of hardware at one location or distributed over a variety of locations remote to the customer. Such hardware can include routers, web servers, database servers, mass storage, and other technologies appropriate for providing application services via the network 242. Alternatively, the data center 232 can be located at a customer's site or sites. In some arrangements, the data center 232 can be operated by the customer itself (e.g., by an information technology department of an organization).

The customer can make use of one or more client machines 252 to access the data center 232 via an application service provider scenario. For example, the client machine 252 can execute a web browser, such as Microsoft Internet Explorer, which is marketed by Microsoft Corporation of Redmond, Wash. In some cases, the client machine 252 may also be an administered device 222.

The administered devices 222 can include any of a wide variety of hardware devices, including desktop computers, server computers, notebook computers, handheld devices, programmable peripherals, and mobile telecommunication devices (e.g., mobile telephones). For example, a computer 224 may be a desktop computer running an instance of the administered software 212.

The computer 224 may also include an agent 228 for communicating with the data center 232 to assist in administration of the administered software 212. In an application service provider scenario, the agent 228 can communicate via any number of protocols, including HTTP-based protocols.

The administered devices 222 can run a variety of operating systems, such as the Microsoft Windows family of operating systems marketed by Microsoft Corporation; the Mac OS family of operating systems marketed by Apple Computer Incorporated of Cupertino, Calif.; and others. Various versions of the operating systems can be scattered throughout-the devices 222.

The administered software 212 can include one or more applications or other software having any of a variety of business, personal, or entertainment functionality. For example, one or more anti-virus, banking, tax return preparation, farming, travel, database, searching, multimedia, security (e.g., firewall), and educational applications can be administered. Although the example shows that an application can be managed over many nodes, the application can appear on one or more nodes.

In the example, the administered software 212 includes functionality that resides locally to the computer 224. For example, various software components, files, and other items can be acquired by any of a number of methods and reside in a computer-readable medium (e.g., memory, disk, or other computer-readable medium) local to the computer 224. The administered software 212 can include instructions executable by a computer and other supporting information. Various versions of the administered software 212 can appear on the different devices 222, and some of the devices 222 may be configured to not include the software 212.

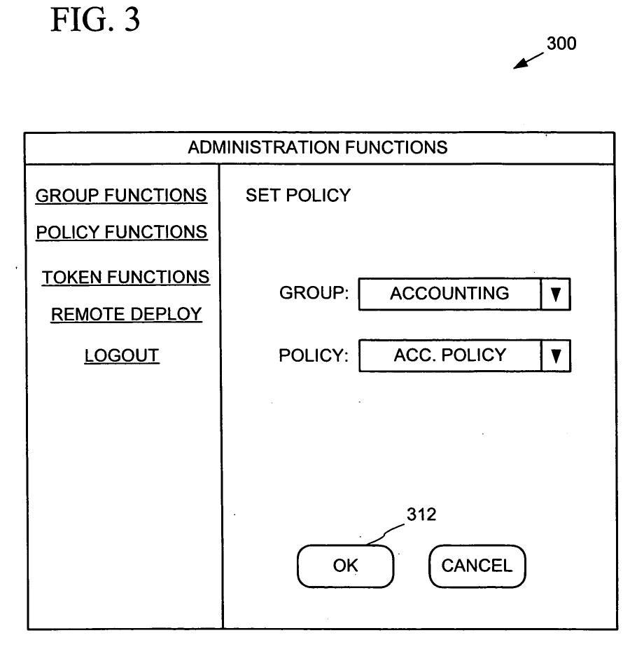

FIG. 3 shows an exemplary user interface 300 presented at the client machine 252 by which an administrator can administer software for the devices 222 via an application service provider scenario. In the example, one or more directives can be bundled into a set of directives called a “policy.” In the example, an administrator is presented with an interface by which a policy can be applied to a group of devices (e.g., a selected subset of the devices 222). In this way, the administrator can control various administration functions (e.g., installation, configuration, and management of the administered software 212) for the devices 222. In the example, the illustrated user interface 300 is presented in a web browser via an Internet connection to a data center (e.g., as shown in FIG. 2) via an HTTP-based protocol.

Activation of a graphical user interface element (e.g., element 312) can cause a request for application services to be sent. For example, application of a policy to a group of devices may result in automated installation, configuration, or management of indicated software for the devices in the group.

In the examples, the data center 232 can be operated by an entity other than the application service provider vendor. For example, the customer may deal directly with the vendor to handle setup and billing for the application services. However, the data center 232 can be managed by another party, such as an entity with technical expertise in application service provider technology.

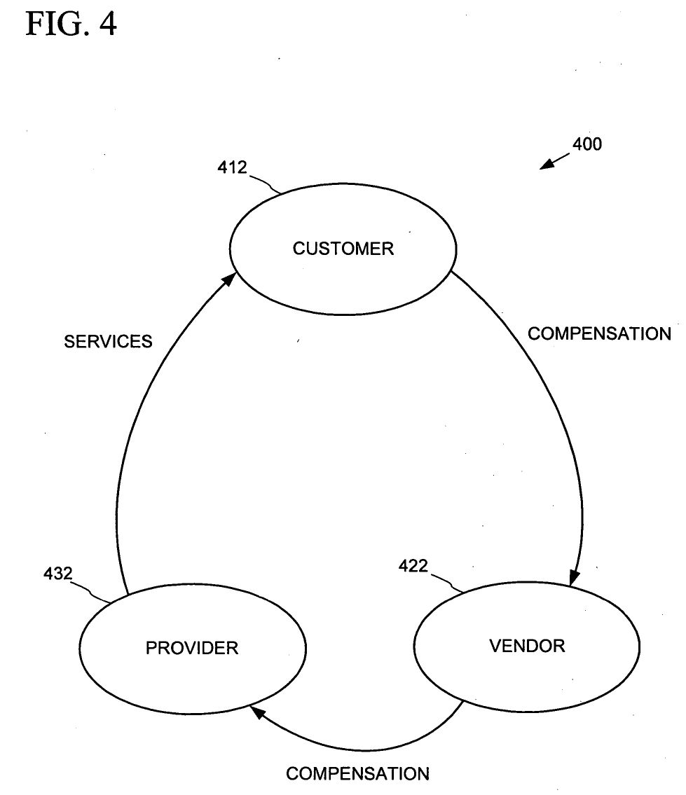

The scenario 100 (FIG. 1) can be accompanied by a business relationship between the customer 112 and the vendor 132. An exemplary relationship 400 between the various entities is shown in FIG. 4. In the example, a customer 412 provides compensation to an application service provider vendor 422. Compensation can take many forms (e.g., a monthly subscription, compensation based on utilized bandwidth, compensation based on number of uses, or some other arrangement (e.g., via contract)). The provider of application services 432 manages the technical details related to providing application services to the customer 412 and is said to “host” the application services. In return, the provider 432 is compensated by the vendor 422.

The relationship 400 can grow out of a variety of situations. For example, it may be that the vendor 422 has a relationship with or is itself a software development entity with a collection of application software desired by the customer 412. The provider 432 can have a relationship with an entity (or itself be an entity) with technical expertise for incorporating the application software into an infrastructure by which the application software can be administered via an application service provider scenario such as that shown in FIG. 2.

Although not shown, other parties may participate in the relationship 400. For example, network connectivity may be provided by another party such as an Internet service provider. In some cases, the vendor 422 and the provider 432 may be the same entity. It is also possible that the customer 412 and the provider 432 be the same entity (e.g., the provider 432 may be the information technology department of a corporate customer 412).

### EXAMPLE 1

### Network References for Acquiring Software

To provide a way to efficiently download and install software, a network reference containing a key associated with the software can be sent to one or more nodes. For example, a network reference can be provided to multiple nodes within an organization to distribute software to the nodes.

A network reference can be used to specify a resource accessible via a network connection. One possible form of a network reference is a Uniform Resource Locator (URL). URLs are strings of characters that specify the locations of resources on the Internet. URLs are typically in a standard format and can include data to be submitted to the resource for processing. Web browsers (e.g., Microsoft's Internet Explorer or Netscape Navigator marketed by Netscape Communications Corporation, based in Mountain View, Calif.) can be used to access resources on the web via URLs. For example, a web server can respond to a request for a particular URL by providing a web page or generating content in some other way.

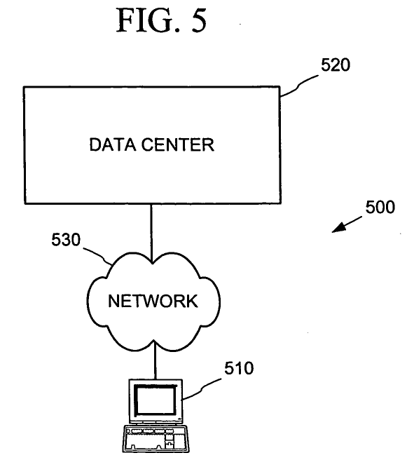

In an illustrated embodiment shown in FIG. 5, an exemplary arrangement 500 includes a computer 510 connected to a data center 520, which may include one or more host computers that respond to network references. The computer 510 can request a resource associated with a network reference via the network 530 (e.g., the Internet). Embodiments described herein can operate in an application service provider arrangement, such as the arrangement 200 of FIG. 2.

### EXAMPLE 2

### Generating a Network Reference

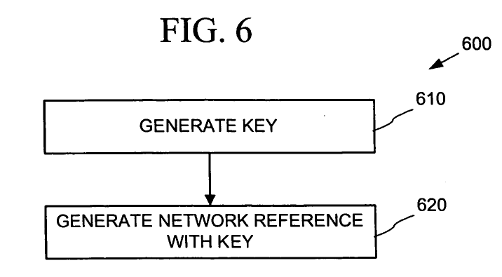

FIG. 6 shows an exemplary method 600 for generating a network reference, such as that for use in the arrangement 500 of FIG. 5. At 610, a key is generated. The key can be associated (e.g., in a database) with one or more software releases, one or more organizations, and one or more groups. The key can be further configured as described in more detail below.

At 620, a network reference comprising the key is generated. The network reference comprising the key can then be provided to a computer to facilitate acquisition of the software associated with the key.

### EXAMPLE 3

### Acquiring Software via a Network Reference

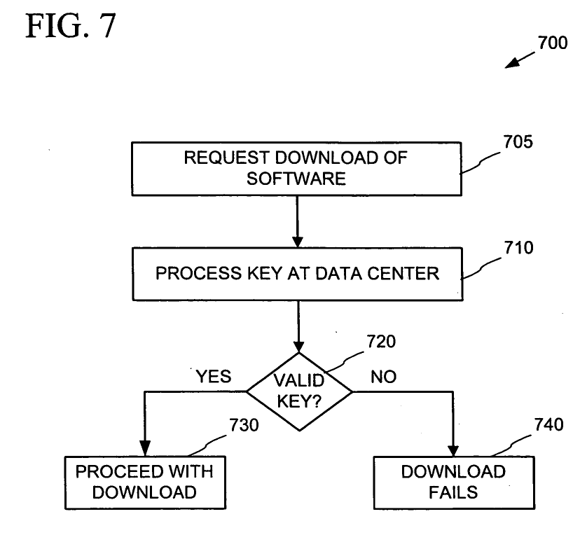

FIG. 7 shows a method 700 for acquiring software via a network reference. At 705, a user on a computer (e.g., the computer 510 of FIG. 5) makes a request to download software via a network (e.g., the network 530) from a data center (e.g., the data center 520) by activating a network reference. The network reference comprising a key is processed by the data center at 710. Details regarding the generation of keys and their inclusion within network references are described below. The data center checks whether the key is valid at 720. If the key is valid, the user is provided access to the requested software at 730. Access to the software can be provided either directly or with a reference to a network location. Installation of the software can be automatically triggered (e.g., by a software component). If the key is not valid, the download fails at 740.

More than one key can be provided per organization. The keys can be separately controlled. For example, a key can expire independently of another, or a key can be revoked independently of another.

### EXAMPLE 4

### Checking Key Validity

A data center (e.g., the data center 520 of FIG. 5) can check whether a key is valid by comparing it against a set of valid keys or using some other procedure. To facilitate checking for key validity, the data center can include a database that has an organization table and one or more configuration tables. Validity can also be determined by reference to an expiration date or other information. A key can be explicitly revoked, and the revocation can be recorded in the database. In this way, the data center can check whether a particular key provided to the data center in a request to download new software or update software is valid by checking the database.

Additionally, the data center can track which node computers belong to which organization (e.g., via a nodes table) and the configuration appropriate for the nodes. Examples of organization tables and nodes tables used in an illustrated embodiment are provided in Tables 1-2 below:

TABLE 1
Exemplary Organizations Database Table
Organizations

| | | | | | |
|---|---|---|---|---|---|
| Column Name | Data Type | Length | Allow Nulls | Default Value | Identity |

| | | | |
|---|---|---|---|
| orgID | uniqueidentifier | 16 | (newid( )) |
| OEMID | nvarchar | 4 | (N’SRES’) |
| releaseThreshold | tinyint | 1 | (100) |
| name | nvarchar | 100 | |

TABLE 2
Exemplary Nodes Database Table
Nodes

| | | | Allow | Default | Iden- |
|---|---|---|---|---|---|
| Column Name | Data Type | Length | Nulls | Value | tity |
| nodeID | Uniqueidentifier | 16 | | (newid( )) | |
| orgID | Uniqueidentifier | 16 | | | |
| groupID | Uniqueidentifier | 16 | | | |
| nodeName | Nvarchar | 50 | | | |
| domainName | Nvarchar | 50 | | | |
| userName | Nvarchar | 50 | | | |
| processorType | Nvarchar | 50 | Yes | | |

It should be noted that the tables presented here are only examples. Other embodiments may use tables comprising additional information, or less information, or may be configured differently. For example, entries in a nodes table may further include entries for an operating system, an operating system version, a default browser, or a “created on” date. Moreover, while a table format is used in an illustrated embodiment, other ways of collecting and organizing such information, such as via a tree structure or an alternative database arrangement (e.g., XML), also may be used.

In some cases, an organization may be sensitive to having its information commingled with other organizations, so a separate table, a separate database, a separate server, or a separate data center can be maintained for such organizations, if desired.

### EXAMPLE 5

### Using Keys Associated with Tokens, Groups, and Other Configuration Information

A user of a node computer can request a download of software by activating a network reference comprising a key indicating an organization ID (an identifier used to represent an entire organization). In this way, software can be distributed to any node in the organization by providing the network reference. Activation of the network reference by the node will result in acquisition and installation of the software.

However, it is possible that a network reference will be abused. For example, the network reference can be sent (e.g., via email) to unauthorized users outside the organization who can then activate it to perform unauthorized acquisition of software. To stop such abuse, an organization-wide identifier can be invalidated, and a new one can then be created. However, creating such an identifier may involve substantial changes to a database (e.g., creating another organization identifier, which may be a primary key in a database relied on in other database tables) or other costly procedures. Using a network reference with a key associated with less than an entire organization avoids the above problems. Such a key is sometimes called a “token.”

A token is one of a number of keys or codes associated with an organization. In an illustrated embodiment, tokens are associated with an organization by being associated with groups that are associated with organizations. However, a token could be directly associated with an organization or associated with an organization in some other way.

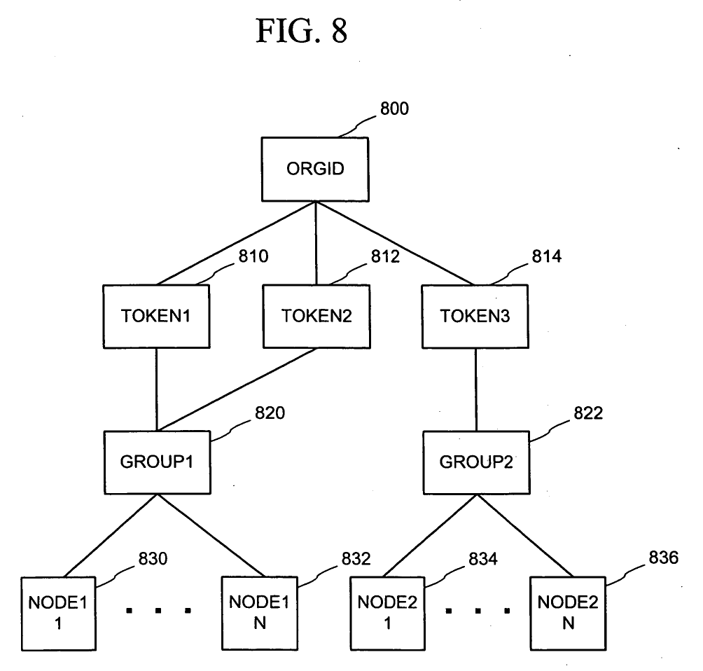

Referring to FIG. 8, an organization's identifier 800 has several associated tokens 810-814. FIG. 8 shows three tokens, but any number of tokens may be used. Nodes are able to request a download or update of software by activating a network reference (e.g., a URL) containing the token, where the token is provided as a key to a data center (e.g., the data center 520 of FIG. 5). Node computers affiliated with the organization can have a unique node identifier, such as node identifiers 830-836. An exemplary format for a table containing node information is provided above in Table 2.

A group may have more than one valid token associated with it; however, in the example, any one token may have only one associated group. For example, in the embodiment illustrated in FIG. 8, token1 810 and token2 812 are each valid tokens for group1 820. In contrast, group2 822 has only one valid token (token3 814).

Upon activation of the token, several nodes, such as the nodes represented by node identifiers 830-836, are associated with each group. However, it is not required for any node to belong to a group, nor is it required to have any groups at all.

Placing nodes into named groups facilitates administration of a large number of nodes. In some embodiments, a group comprises nodes having certain characteristics in common. For example, a set of nodes can be placed into a group named “lab” to designate that the nodes are machines in a lab where software functionality is tested. A group can have one or more nodes as members of the group and be associated with a group identifier. The group identifier can then be associated with various configuration directives. In the example of the “lab” group, the computers in the group might be the first to receive new versions of software for testing to ensure reliability before other groups install the software.

To accomplish such an arrangement, a token can be created for the “lab” group and then provided to an arbitrary list of computers. Computers installing software via the token would then be placed in the “lab” group. Computers can subsequently be moved to another group.

As explained above, in an illustrated embodiment, a data center (e.g., the data center 520) checks whether the key is valid by comparing it against a list of valid keys. In addition to organization tables and nodes database tables, the data center can include a database that has a token table, a group table, and/or one or more other configuration tables (e.g., a policies table). In this way, the data center can track whether a particular token is valid when a node requests access to software.

Upon placing the node in a group, the data center can also determine which node computers belong to which organization or group (e.g., via a nodes table) and the configuration appropriate for the nodes. Examples of tokens tables, groups tables, and policies tables used in an illustrated embodiment are provided in Tables 3-5 below:

TABLE 3
Exemplary Tokens Database Table
Tokens

| | | | | | |
|---|---|---|---|---|---|
| Column Name | Data Type | Length | Allow Nulls | Default Value | Identity |

| | | | |
|---|---|---|---|
| tokenID | Uniqueidentifier | 16 | (newid( )) |
| orgID | Uniqueidentifier | 16 | |
| groupID | Uniqueidentifier | 16 | |
| name | Nvarchar | 50 | (N′Default Token′) |
| enabled | Bit | 1 | (1) |
| createdOn | Datetime | 8 | (getutcdate( )) |
| expiresOn | Datetime | 8 | |

TABLE 4
Exemplary Groups Database Table
Groups

| | | | | | |
|---|---|---|---|---|---|
| Column Name | Data Type | Length | Allow Nulls | Default Value | Identity |

| | | | |
|---|---|---|---|
| groupID | Uniqueidentifier | 16 | (newid( )) |
| policyID | Uniqueidentifier | 16 | |
| name | Nvarchar | 50 | (N′.Unassigned′) |

TABLE 5
Exemplary Policies Database Table
Policies

| | | | | | |
|---|---|---|---|---|---|
| Column Name | Data Type | Length | Allow Nulls | Default Value | Identity |

| | | | |
|---|---|---|---|
| policyID | Uniqueidentifier | 16 | (newid( )) |
| orgID | Uniqueidentifier | 16 | |
| licenseID | Uniqueidentifier | 16 | |
| releaseStateID | Tinyint | 1 | (4) |
| localeID | Nvarchar | 4 | |
| name | Nvarchar | 50 | (N′Default Policy′) |

It should be noted that these database tables also are only examples. Other embodiments may use tables comprising additional information, or less information, or may be configured differently. Moreover, while a table format is used in an illustrated embodiment, other ways of collecting and organizing such information, such as via a tree structure or an alternative database arrangement (e.g., XML), also may be used.

### EXAMPLE 6

### Exemplary Downloadable Software

As explained above, nodes are able to request software by activating a network reference containing a key such as a token. In one embodiment, after it has been determined that the key in a request to download or update software is valid, the software is downloaded in the form of a cabinet file. The cabinet file can contain an .INF file, which contains instructions for downloading software in the cabinet file, and software to be installed on the requesting computer. The contents of the cabinet file can be downloaded and expanded, and the software can be installed on the requesting computer.

In one embodiment, the software installed is minimal agent software, which enables client computers to communicate with and download files from a server either inside or outside the organization.

### EXAMPLE 7

### Managing Tokens

In an illustrated embodiment, a computer user, such as an administrator in an organization, can manage tokens for use in administering software on computers in the organization. This embodiment and other embodiments described below involve web page elements relating to HTML. However, it should be understood that other languages suitable for web page development could be used.

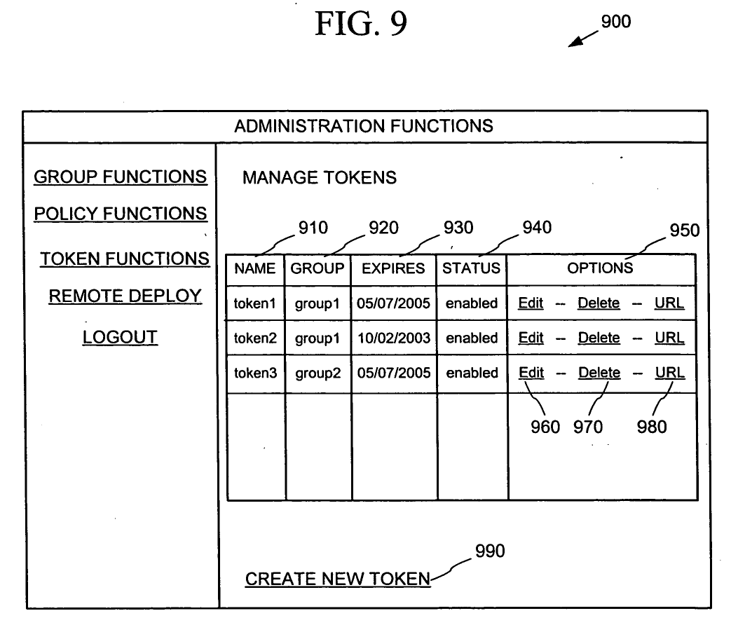

FIG. 9 shows a user interface 900 on a web page for managing tokens in an illustrated embodiment. A user browsing the web page is presented with information relating to various currently existing tokens, if any. In an illustrated embodiment, the information includes a token name 910, an associated group 920 (if any), an expiration date 930 (if any), a token status 940 (e.g., an indicator of, for example, whether or not a token is currently active or enabled), and token options 950. Token options 950 may include an edit (or update) option 960, a delete option 970, or a generate network reference option 980. An token that is not enabled is considered invalid if an attempt is made to access software with it. Thus, a token can be revoked by disabling. If the user wishes to create a new token, the user can activate a user interface element such as a hyperlink 990.

In other embodiments, information in user interface 900 may contain all of the above information, less than all of the above information, additional information, or some combination thereof.

### EXAMPLE 8

### Creating New Tokens

To create a new token, a user in an illustrated embodiment may activate a user interface element such as a hyperlink 990. Activating a hyperlink 990 may result in presentation to the user of yet another web page by which information related to the new token can be entered. Upon creation, the token can be associated (e.g., in a database) with an organization (e.g., the organization for which the user is creating the token).

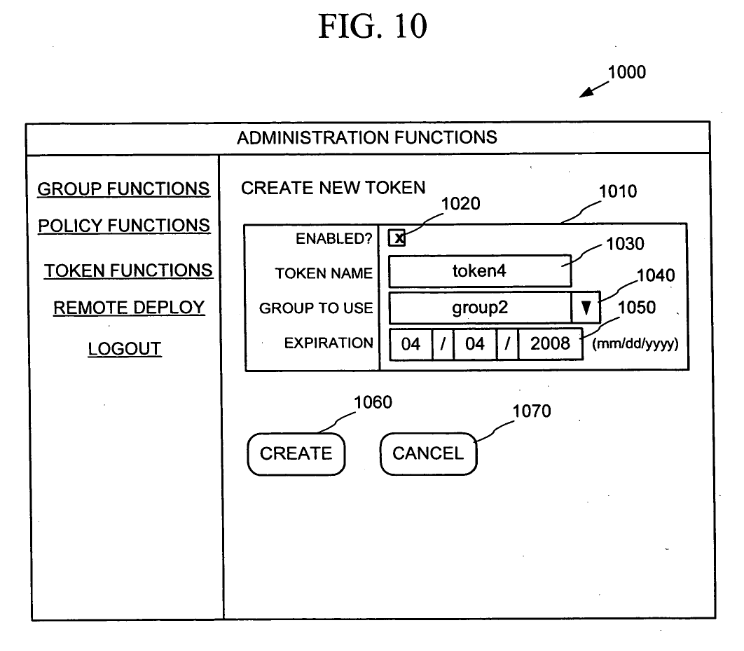

Referring to FIG. 10, the user may be presented with several options for entering information for a new token in a user interface such as the user interface 1000. Within an information window 1010, a user can select whether the new token should be enabled (e.g., active) via a user interface element such as the checkbox 1020. In the illustrated example, the checkbox 1020 is marked with an “X”; thus, the token is enabled.

A user may also enter a token name, if desired, in a user interface element such as the text field 1030. In the illustrated example, the text field 1030 shows the token name as “token4.” If no name is entered, a default name may be substituted. For example, referring to Table 3 above, a default name in an illustrated embodiment can be “Default Token.” Other default values for a token name also may be used. If a user desires to assign a token to a group of nodes, the user may select a group via a user interface element such as the drop-down box 1040. However, tokens need not be assigned to groups, and nodes in the organization of the user need not belong to groups. If a user desires to set an expiration date for the token (e.g., a date after which the token will no longer be valid), the user may do so by entering a date in a user interface element such as the date field 1050. In an illustrated embodiment, the date field 1050 shows that token4 is set to expire on Apr. 4, 2008. Date formats other than the format shown may be used.

At any time, the user may choose to create a token with the information provided, or cancel the creation process, by activating user interface elements such as the push buttons 1060 and 1070.

In other embodiments, information in user interface 1000 may contain all of the above information, less than all of the above information, additional information, or some combination thereof. For example, user interface 1000 may not include the drop down box 1050 in cases where an organization in which a token is used does not use groups. As another example, an additional field, such as an installation limit field, may be presented in user interface 1000 in cases where a user is given an option to set limits on how many installations or software updates may be performed using a particular token. After the number has reached the specified limit, additional installations via the token are not permitted.

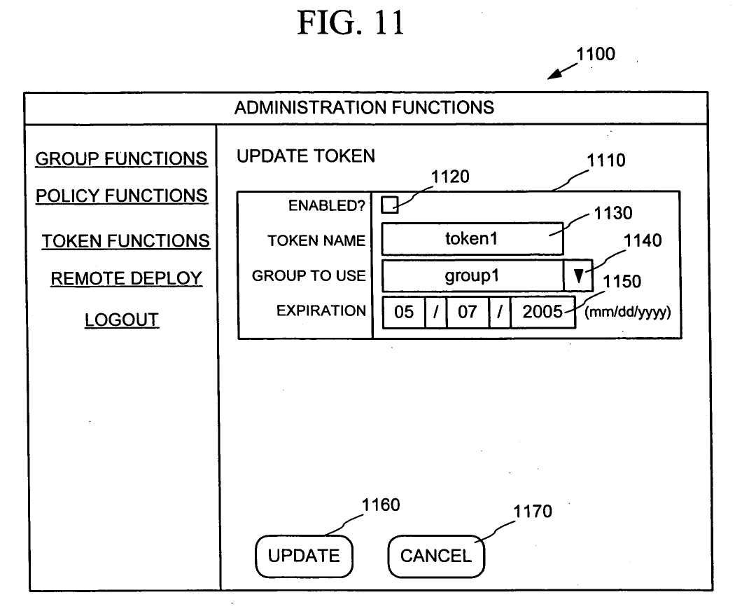

Additionally, information such as that provided in the user interface 1100 of FIG. 11 may alternatively be provided automatically (e.g., by the data center 520 in FIG. 5) without user input. For example, in some cases, the ability to set limitations on numbers of installations may be withheld from users such as organization administrators and/or limited to operators of the data center.

### EXAMPLE 9

### Editing or Updating Existing Tokens

Referring again to FIG. 9, to update or edit an existing token, a user in an illustrated embodiment may activate a user interface element such as the hyperlink 960. Activating the hyperlink 960 may result in presentation to the user of yet another web page for configuring the token.

Referring to FIG. 11, the user may be presented with several options for entering or editing information for an existing token in a user interface such as the user interface 1100. Within the information window 1110, a user can select whether the existing token should be enabled (e.g., active) via a user interface element such as the checkbox 1120. In the illustrated example, the checkbox 1120 is not marked with an “X”; thus, the token is not enabled.

A user may also edit the token name if desired in a user interface element such as the text field 1130. In an illustrated embodiment, the text field 1130 shows the token name as “token1.” If no name is entered, or if an existing name is deleted, a default name may be substituted. For example, referring to Table 3 above, a default name in an illustrated embodiment can be “Default Token.” Other default values for a token name also may be used. If a user desires to assign a previously unassigned token to a group, change a token so that it is not assigned to any group, or assign a token to a different group, the user may select a group (or some other option such as “unassigned”) via a user interface element such as the drop-down box 1140.

In the illustrated example, token1 is assigned to group1. Tokens need not be assigned to groups, and nodes in the organization of the user need not belong to groups. If a user desires to set an expiration date for the token (e.g., a date after which the token will no longer be valid), or to edit an existing expiration date, the user may do so by entering a new date or editing an existing date in a user interface element such as the date field 1150. In the illustrated example, the date field 1150 shows that token1 is set to expire on May 7, 2005. Date formats other than the format shown may be used.

At any time, the user may choose to update a token to reflect any modifications to the token information, or cancel the editing/updating process, by activating user interface elements such as the push buttons 1160 and 1170.

In other embodiments, information in the user interface 1100 may contain all of the above information, less than all of the above information, additional information, or some combination thereof. For example, the user interface 1100 may not include the drop down box 1150 in cases where an organization in which a token is used does not use groups. As another example, an additional field, such as an installation limit field, may be presented in the user interface 1100 in cases where a user is given an option to set or edit limits on how many installations or software updates may be performed using a particular token. After the number has reached the specified limit, additional installations via the token are not permitted.

Additionally, information such as that provided in the user interface 1100 may alternatively be provided automatically (e.g., by the data center 520 in FIG. 5) without user input. For example, in some cases, the ability to set limitations on numbers of installations may be withheld from users such as organization administrators and/or limited to operators of the data center.

### EXAMPLE 10

### Deleting Existing Tokens

Referring again to FIG. 9, to delete an existing token, a user in the illustrated example may activate a user interface element such as the hyperlink 970. Activating the hyperlink 970 may result in an immediate deletion of the token, or may result in presentation to the user of yet another web page. For example, the user may be prompted (e.g., in another web page) to confirm that the token selected for deletion should indeed be deleted. After deleting the token, the user may be presented with yet another web page, such as a web page showing a list of tokens with the deleted token omitted.

### EXAMPLE 11

### URLs Associated with Tokens

While browsing the user interface 900, a user in an illustrated embodiment also may activate a user interface element, such as the hyperlink 980, to generate a URL as a network reference for a particular token. Activating the hyperlink 980 can result in presentation to the user of yet another web page that presents the URL.

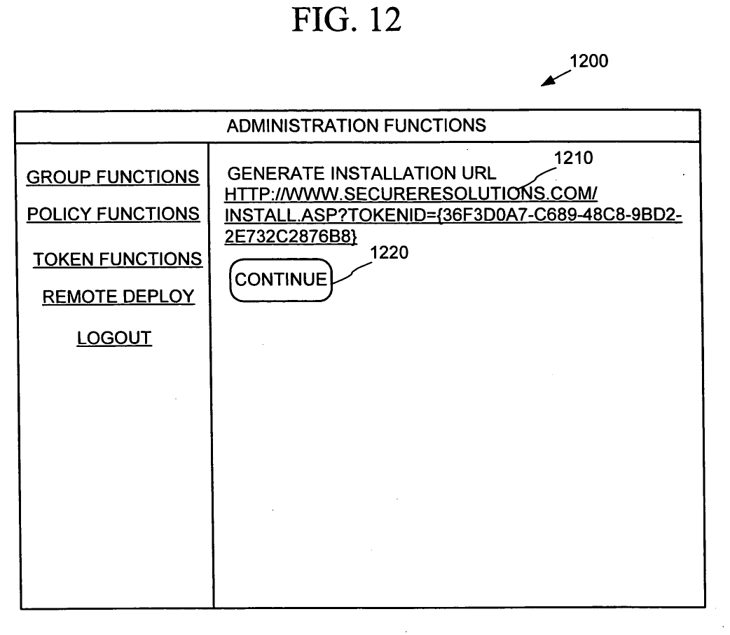

Referring to FIG. 12, the user may be presented with a URL, such as the URL 1210, in a user interface such as the user interface 1200. In the illustrated example, the URL 1210 is generated by a data center (e.g., the data center 520 of FIG. 5), combining an Internet location (e.g., a dynamically-generated web page) with a key, where the key is a globally unique identifier (GUID). The URL 1210 can then be provided to nodes in an organization with which the user is associated, or to nodes in some other organization (e.g., any organization associated with the token). Activating the URL 1210 from a node, or any other computer with access to a network such as the Internet, results in a request to download new software, or a software update, from the location specified in the URL. The activating node can also be placed in the group associated with the token in the URL.

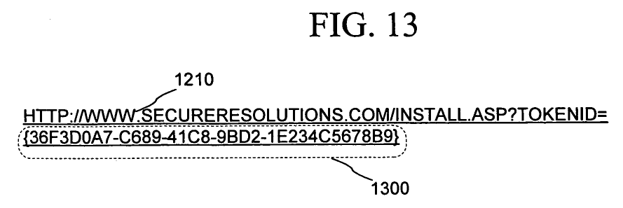

Referring to FIG. 13, the URL 1210 is shown in detail. The URL 1210 includes a GUID key (e.g., a token), which can be checked (e.g., by data center 520 in FIG. 5) to determine whether access to software may be provided when the URL is activated (e.g., clicked on). Details of various embodiments involving checking for valid keys are provided above.

In an illustrated embodiment, the key 1300 in the URL 1210 is a token ID in a query string. A query string is an optional part of a URL that provides data input to a computer (e.g., web server) at the location specified in the URL. The URL 1210 contains a key 1300 (in this case, a token ID) in a query string, thus the token ID is presented as input to a computer, via a protocol such as HTTP, at the location specified. In an illustrated embodiment, the location is “www.secureresolutions.com/install.asp/.”

However, the key need not be presented as a query string. Other methods for providing input to a computer at a particular location via a URL can be used. For example, input also may be provided as a fragment identifier, to specify a particular location in a document on a computer.

Referring again to FIG. 12, after generating the URL, the user may continue to manage tokens by activating a user interface element such as the push button 1220.

In other embodiments, information in user interface 1100 may contain all of the above information, less than all of the above information, additional information, or some combination thereof. For example, the user interface 1100 may not include the push button 1220. Instead, a user may, for example, be automatically redirected to another web page after generating the URL. As another example, an additional user interface element, such as a hypertext link, may be presented in the user interface 1200 which, when activated, generates an electronic mail message containing the URL 1210, which can then be sent to a desired node, such as an end user in an organization or by another user, such as an organization's administrator.

Additionally, information such as that provided in the user interface 1100 may alternatively be provided automatically (e.g., by the data center 520 in FIG. 5) without user input. For example, referring to FIG. 9, a URL, such as a URL associated with a token, may be provided in the user interface 900 without a user activating a user interface element such as the hypertext link 980.

### EXAMPLE 12

### Providing Access to Software by Many Enterprises

In some situations, it may be desirable for one vendor to host application services (e.g., provides tokens and performs other tasks related to software administration) for more than one organization. For example, a vendor can host a plurality of customers to avoid having a data center for each customer, to avoid having to hire separate staff for each customer, or to otherwise reduce the cost of providing the services. The technologies described herein can be implemented in such a scenario.

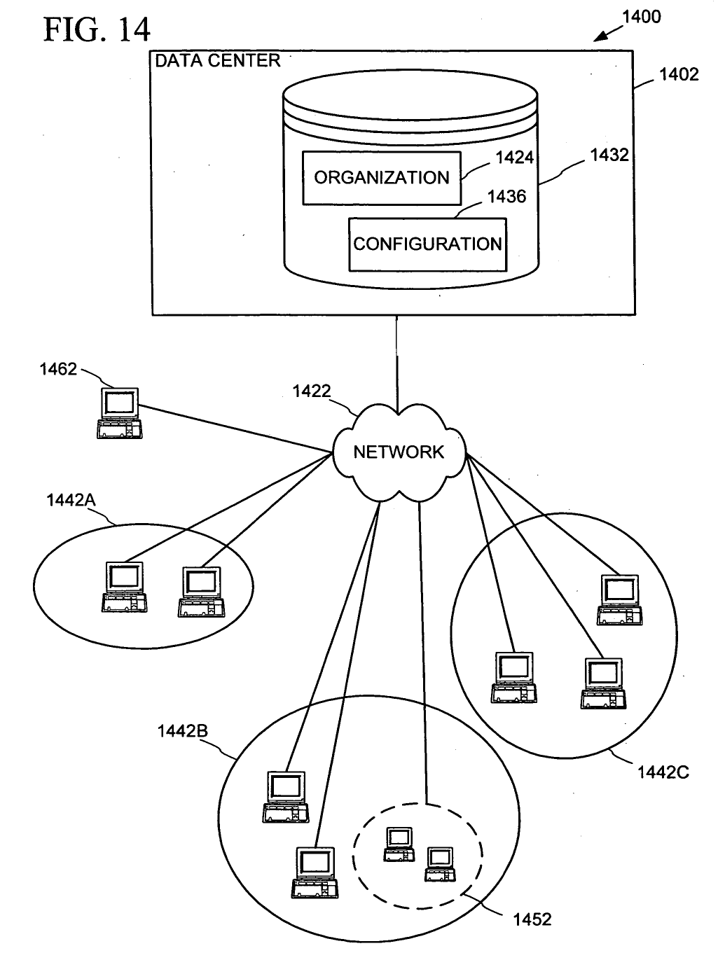

FIG. 14 depicts an exemplary scenario 1400 in which a vendor hosts application services for more than one customer. The vendor can act as an application service provider or delegate the hosting responsibilities to another entity if desired. Also, it is possible for one application service provider to provide services for a plurality of vendors. It is also possible for the pictured scenario 1400 to be applied to a single organization (e.g., departments or geographical locations can be considered sub-organizations within such an organization).

In the example, a data center 1402 can include a variety of hardware and software (e.g., web servers) for processing requests from a variety of nodes via the network 1422. The network 1422 may be the Internet or some other network. In the case of the Internet, there may be one or more firewalls between the data center 1402 and the nodes administered.

The data center 1402 can include a database 1432 that has an organization table 1434 and one or more configuration tables 1436. In this way, the database 1432 can track which nodes belong to which organization (e.g., via a nodes table) and the configuration appropriate for the nodes. Various other tables can also be included (e.g., a groups table). In some cases, an organization may be sensitive to having its information commingled with other organizations, so a separate table, a separate database, a separate server, or a separate data center 1402 can be maintained for such organizations, if desired.

As shown, three organizations 1442A, 1442B, and 1442C are availing themselves of the services provided by the application service provider via the data center 1402 over the network 1422. Within the organization, nodes can be associated into groups or subnets (e.g., the group 1452). Administration can be accomplished by an administrator accessing the data center 1402 (e.g., via an HTTP-based protocol) from within the respective organization, group, or subnet.

It is also possible that the organizations be administered by yet another entity via another computer 1462. For example, a consulting firm can perform software administration functions for the three organizations by accessing web pages over the Internet. The initial installation of agents to the nodes may be challenging in a situation where no administrator is behind the organization's firewall, but such installation can be accomplished by emailing an appropriate network reference as described herein to a user at the node. When activated, the hyperlink can install the appropriate agent software.

Providing access to software as described herein can be administered via any of the illustrated scenarios. For example, an administrator inside or outside of an organization can access the data center 1402 to manipulate configuration settings to create, modify, or delete tokens. Security measures can be put into place to prevent unauthorized manipulation of configuration settings.

### EXAMPLE 13

### Policies

A set of configuration directives can be grouped into a named set called a policy. The policy can include a stage of software to be distributed to nodes associated with the policy. The policy can be associated with nodes via the group mechanism described herein.

### EXAMPLE 14

### Exemplary Techniques for Employing Tokens

The described tokens can be used in a variety of ways to provide access to software. The tokens can be provided over a network.

For example, a network reference comprising the token can be distributed via email. In such an arrangement, a user receiving an email with the network reference can activate (e.g., click on) the network reference to pull up a web page that triggers installation of the associated software. Such a web page can be generated dynamically (e.g., via Microsoft Corporation's Active Server Pages technology).

For example, an appropriate “<OBJECT>” tag can be included in the web page generated when the network reference is activated. An associated distribution unit, (e.g., a .CAB file) can then be loaded for installation. A facility for acquiring the distribution unit (e.g., Microsoft Corporation's Internet Component Download) can be invoked upon presentation of the web page. Included in the distribution unit can be a software component (e.g., and ActiveX control) that invokes an executable (e.g., a utility for installing software related to the key).

Functionality (e.g., a hyperlink on the user interface 1200 of FIG. 12) can be provided by which a network reference comprising a token is distributed via email to one or more nodes (e.g., in a group) along with instructions on what the network reference is and how to use it.

The token can also be used in a remote deployment (e.g., push) scenario. For example, in the case of a remote deployment utility, a token can be provided along with one or more nodes (e.g., in a group) on which software associated with the token is to be installed. Upon activation of the remote deployment utility, software associated with the token can be distributed to the nodes in the group. Installation can be automatically accomplished across a large number of machines. In such a case, a network reference need not be used; thus, a user need not activate a network reference to accomplish software distribution via the token.

### EXAMPLE 15

### Registering Node for Software Administration via a Token

The described tokens can be used to register a node for software administration (e.g., in an application service provider scenario). For example, a token can be associated with a particular group or organization as shown in FIG. 10. The token can then be distributed to nodes in the group via email (e.g., as a network reference) or otherwise provided to nodes (e.g., via a remote deployment utility).

The token can then provide access to agent software that can be installed at the node. When a request for software associated with a token is received by a data center, it responds with an appropriate version of the agent software. The agent software can then be installed at the node. During the installation process, the node can generate an node identifier (e.g., a GUID) and provide it to the data center. The data center can then register the node as an active node at which software administration can be performed. The node can also be associated with the organization and group associated with the token.

Software administration directives can be received at a data center (e.g., via an application service provider scenario using a user interface such as that shown in FIG. 3). The software administration directives can be implemented by the agent after it is installed. For example, when the agent software executes, it can periodically report to or receive instructions from the data center, again using the earlier-generated node identifier. For example, the agent can request updates to software. Initially, a small (e.g., minimal) agent can be installed. Subsequently, additional functionality can be acquired.

### EXAMPLE 16

### Associating Software with a Key

In any of the examples described herein, a key (e.g., a token) can be associated with particular software. In some instances, software to be associated with the key can be determined based on user input (e.g., a software distribution can be explicitly specified or appropriate agent software can be selected based on a specified operating system).

It is also possible that the software need not be explicitly specified. For example, it may be that only one type of software is administered by a particular data center, so explicitly specifying the software might be superfluous. Alternatively, if a key is associated with a group, the appropriate software can be determined with reference to the group. For example, the group may specify an operating system, and the operating system may indicate appropriate software. The software associated with a key may not be so associated until the key is activated. Thus, late binding of software to the key can be achieved.

The software associated with a key can be packaged in a distribution-friendly format (e.g., .CAB, .ZIP, or .SEA). An installation utility can be packaged with the software to facilitate installation. The installation utility can perform other functions (e.g., generating a node identifier).

### EXAMPLE 17

### Exemplary Techniques for Processing Tokens

Upon receipt of a token by a data center, various steps can be taken. For example, if a node provides an indication of the node's identity along with the token, the data center can place the node (e.g., via its identifier) into an appropriate group (e.g., the group associated with the token) in a database.

In this way, nodes can be automatically placed in the proper groups upon activation of a network reference. Subsequently, when functions (e.g., administration functions) are performed for a group, the node in the group will be included. For example, if an agent at a node requests a software update, the node identifier will place the node into its proper group and software to be distributed to the group can be provided.

### EXAMPLE 18

### Anti-Virus Software Administration

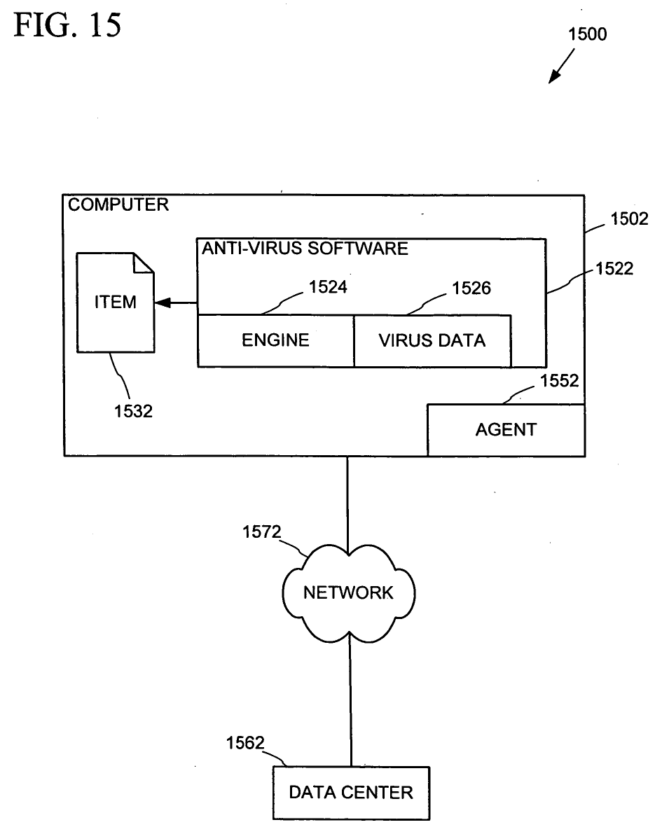

In any of the examples described herein, the software being installed or otherwise administered can be anti-virus software or an agent for an anti-virus software system. An exemplary anti-virus software arrangement 1500 is shown in FIG. 15.

In the arrangement 1500, a computer 1502 (e.g., a node) is running the anti-virus software 1522. The anti-virus software 1522 may include a scanning engine 1524 and the virus data 1526. The scanning engine 1524 is operable to scan a variety of items (e.g., the item 1532) and makes use of the virus data 1526, which can contain virus signatures (e.g., data indicating a distinctive characteristic showing an item contains a virus). The virus data 1526 can be provided in the form of a file.

A variety of items can be checked for viruses (e.g., files on a file system, email attachments, files in web pages, scripts, etc.). Checking can be done upon access of an item or by periodic scans or on demand by a user or administrator (or both).

In the example, agent software 1552 communicates with a data center 1562 (e.g., operated by an application service provider) via a network 1572 (e.g., the Internet). Communication can be accomplished via an HTTP-based protocol. For example, the agent 1552 can send queries for updates to the virus data 1526 or other portions of the anti-virus software 1522 (e.g., the engine 1524). Such communications can include a node identifier that associates the computer 1502 with a group within an organization.

### Alternatives

Having described and illustrated the principles of our invention with reference to illustrated embodiments, it will be recognized that the illustrated embodiments can be modified in arrangement and detail without departing from such principles. It should be understood that the programs, processes, or methods described herein need not be related or limited to any particular type of computer apparatus. Various types of general purpose or specialized computer apparatus may be used with or perform operations in accordance with the teachings described herein. Elements of the illustrated embodiment shown in software may be implemented in hardware and vice versa.

Technologies from the preceding examples can be combined in various permutations as desired. Although some examples describe an application service provider scenario, the technologies can be directed to other arrangements. Similarly, although some examples describe anti-virus software, the technologies can be directed to other arrangements.

Although installation of software is described, such installation can include updating software already on a node.

In view of the many possible embodiments to which the principles of our invention may be applied, it should be recognized that the detailed embodiments are illustrative only and should not be taken as limiting the scope of our invention. Rather, we claim as our invention all such embodiments as may come within the scope and spirit of the following claims and equivalents thereto.

We claim:

1. A method of providing access to software over a network to a plurality of computers, the method comprising:
generating a plurality of keys, wherein the keys are associated with a single organization, and validity of at least one of the keys is controllable separately from another one of the keys;
receiving a received key out of the keys in a request for software associated with the received key; and
over the network, selectively providing access to the software associated with the received key based on whether the received key is valid.

2. The method of claim 1 wherein the plurality of network references comprise keys associated with the organization in a database.

3. The method of claim 1 wherein providing access to the software comprises providing access to the software in a downloadable format.

4. The method of claim 1 wherein the software is agent software for administering administered software via an application service provider scenario.

5. The method of claim 4 wherein the administered software is anti-virus software.

6. The method of claim 1 wherein the plurality of network references comprise Uniform Resource Locators.

7. The method of claim 1 wherein the key is received from a requesting node, the method further comprising:
responsive to receiving an indication of an identity of the requesting node, associating the identity with a group associated with the key.

8. The method of claim 7 further comprising:
receiving a configuration directive for the group via an application service provider scenario; and
implementing the configuration directive for the node.

9. A method of generating a key for providing access to software associated with the key to a plurality of nodes within an organization, the method comprising:
generating a key;
associating the key with the organization;
associating the key with a group; and
providing the key for distribution to a node whereat software associated with the key is to be installed; wherein at least one other key can be associated with the organization and is separately revocable.

10. The method of claim 9 wherein:
the group is associated with the organization in a database; and
associating the key with the organization comprises associating, via the database, the key with the group associated with the organization.

11. The method of claim 9 further comprising:
receiving the key and a node identifier from a node; and
responsive to receiving the key and the node identifier from the node, associating the node with the group in a database.

12. The method of claim 9 wherein the key is further associated with an expiration date.

13. The method of claim 9 wherein the providing is performed via an application service provider scenario.

14. A method of administering software at a node, the method comprising:
from the node, receiving a request for software associated with a key, wherein the key is associated with a group;
responsive to the request, providing the software associated with the key;
receiving a node identifier identifying the node; and
responsive to receiving the node identifier identifying the node, associating the node with the group for purposes of software administration.

15. The method of claim 14 wherein the request for software associated with a key comprises an HTTP request comprising the key.

16. The method of claim 14 wherein
the software is administered at more than one node in an organization; and
more than one key is associated with the organization.

17. The method of claim 14 further comprising:
verifying that the key is valid with reference to a database.

18. The method of claim 14 further comprising:
receiving a configuration directive for the group of the node via an application service provider scenario; and
implementing the configuration directive for the node.

19. The method of claim 14 wherein the software comprises an agent for implementing configuration directives at the node.

20. A method of downloading software from a server computer to a downloading computer, wherein the downloading computer is one of a plurality of computers associated with an organization, the method comprising:
accessing the server computer with the downloading computer; and
requesting a download of software, wherein the requesting comprises providing a key as input to the server computer;
wherein the accessing comprises processing a network reference comprising the key, and wherein the key is one of a plurality of keys associated with the organization.

21. The method of claim 20 wherein the network reference comprises a Uniform Resource Locator.

22. The method of claim 20 wherein the key comprises a token identifier.

23. The method of claim 20 wherein the key is associated with a group of computers for which software administration directives can be implemented.

24. The method of claim 20 wherein the server computer is operated by an application service provider.

25. The method of claim 20 further comprising downloading the requested software from the server computer to the downloading computer.

26. The method of claim 25 wherein the requested software comprises an update of existing software on the downloading computer.

27. A method of presenting a user interface for generating a network reference comprising a token for installing software at one or more computers, the method comprising:
receiving a request to create the network reference comprising the token for installing software at one or more computers;
receiving an indication of a named group within an organization with which computers receiving the network reference are to be associated; and
presenting the network reference comprising a token for installing software at one or more computers.

28. The method of claim 27 further comprising:
receiving an expiration date for the token.

29. A computer-implemented method of installing agent software at a computer operated by an organization to facilitate anti-virus software administration at the computer, the method comprising:
receiving a reference to a uniform resource locator comprising a token, wherein the token is associated with a named group, and more than one token can be provided per organization;
based on the token, providing a dynamically-generated web page comprising a software component operable to initiate installation of the agent software;
after installing the agent software at the computer, receiving from the agent an indication of a node identifier associated with the computer;
based on the node identifier, associating the computer with the named group in a database;
receiving a query from the computer regarding anti-virus software to be installed at the computer; and
providing a release of anti-virus software to the computer based on the named group with which the computer is associated.

30. A computer-readable medium comprising computer-executable instructions stored thereon for performing the method of any of the preceding claims.

31. A system for downloading software over a network, the system comprising:
a data center operable to generate network references comprising a key for authorizing downloading of software, wherein the key is one of a plurality of keys associated with an organization; and
a communication link to a network, wherein the communication link is operable to allow communication between the data center and an accessing computer operable to access the data center.

32. The system of claim 31 wherein the network references comprise uniform resource locators.

33. The system of claim 31 further comprising a downloading computer operable to request a download of software using a network reference generated by the data center.

34. A system for receiving tokens for installation of software, the system comprising:
means for receiving a received token;
means by which the received token is associated with a group, wherein more than one group can be associated with an organization;
means for determining whether the token is valid; and
means for receiving a node identifier from a node; and
means for, upon receiving the node identifier and the token, associating the node of the node identifier with the group associated with the received token.

35. An install string-comprising:
a token for providing access to software over a network, wherein the token is one of a plurality of tokens associated with an organization.

36. The install string of claim 35 wherein the install string comprises a uniform resource locator.

37. The install string of claim 35 wherein the software comprises agent software for implementing configuration directives related to administered software at a node.

38. The install string of claim 35 wherein the string is valid for a finite number of accesses to the software.
